(19) United States
(12) Patent Application Publication
(10) Pub. No.: US 2013/0060991 A1
(43) Pub. Date: Mar. 7, 2013

(54) SOLID STATE DRIVE AND GARBAGE COLLECTION CONTROL METHOD THEREOF

(71) Applicants: Shih-Chiang Lee, Hsinchu (TW); Ling-Feng Chen, Hsinchu (TW)

(72) Inventors: Shih-Chiang Lee, Hsinchu (TW); Ling-Feng Chen, Hsinchu (TW)

(73) Assignee: LITE-ON IT CORPORATION, Taipei (TW)

(21) Appl. No.: 13/413,785

(22) Filed: Mar. 7, 2012

(30) Foreign Application Priority Data
Sep. 5, 2011 (CN) 201110260719.5

(51) Int. Cl. G06F 12/02

(52) U.S. Cl. 711/103; 711/E12.008; 711/E12.009

(57) ABSTRACT

A garbage collection control method for a solid state drive is provided. The garbage collection control method includes the following steps. Firstly, a total number of releasable spaces in a plurality of data-containing blocks of a flash memory is calculated and defined as A. A total number of spaces in a plurality of blank blocks of the flash memory is calculated and defined as B. If the ratio B/A is smaller than a first threshold value, a garbage collection is performed. During the garbage collection is performed, if the ratio B/A is larger than a second threshold value, the garbage collection is ended. The first threshold value is smaller than the second threshold value.

This application claims the benefit of People's Republic of China Application Serial No. 201110260719.5, filed Sep. 5, 2011, the subject matter of which is incorporated herein by reference.

### FIELD OF THE INVENTION

The present invention relates to a solid state drive and a control method thereof, and more particularly to a solid state drive and a garbage collection control method thereof.

### BACKGROUND OF THE INVENTION

As is well known, a solid state drive (SSD) is a data storage device that uses a NAND-based flash memory to store data. The NAND-based flash memory is a non-volatile memory. After data are written to the flash memory, if no power is supplied to the flash memory, the data are still retained in the flash memory.

FIG. 1 is a schematic functional block diagram illustrating a conventional solid state drive. As shown in FIG. 1, the solid state drive 10 comprises a controlling unit 101 and a flash memory 105. The flash memory 105 is accessible by the controlling unit 101 through an internal bus 107. In addition, the controlling unit 101 is in communication with a host 12 through an external bus 20. Consequently, commands and data can be transmitted between the controlling unit 101 and the host 12. Generally, the external bus 20 is a USB bus, an IEEE 1394 bus, an SATA bus, or the like.

Generally, the flash memory 105 comprises a plurality of blocks. Each block comprises a plurality of pages (or sectors), for example 64 pages. Each page is typically 4K bytes in size. Due to the inherent properties of the flash memory 105, at least one page is written at a time during the writing operation is performed, and the erasing operation is performed in a block-wise fashion.

Due to the inherent properties of the flash memory 105, if the data of a specified page of a block needs to be updated, the controlling unit 101 fails to directly correct the data of the page. Whereas, the data to be updated is written in another blank page by the controlling unit 101. Under this circumstance, the old page is considered as an invalid page, and the data contained therein is considered as an invalid data. Moreover, after many times of accessing operations by the host 12, the flash memory 105 may contain a great number of invalid pages and invalid data, which occupy a lot of space of the flash memory 105.

Therefore, there is a need of providing a method for efficiently reducing the invalid pages and the invalid data in order to increase the space of the flash memory.

### SUMMARY OF THE INVENTION

A first embodiment of the present invention provides a garbage collection control method for a solid state drive. The garbage collection control method includes the following steps. Firstly, a total number of releasable spaces in a plurality of data-containing blocks of a flash memory is calculated and defined as A. A total number of spaces in a plurality of blank blocks of the flash memory is calculated and defined as B. If the ratio B/A is smaller than a first threshold value, a garbage collection is performed. During the garbage collection is performed, if the ratio B/A is larger than a second threshold value, the garbage collection is ended. The first threshold value is smaller than the second threshold value.

A second embodiment of the present invention provides a garbage collection control method for a solid state drive. The garbage collection control method includes the following steps. Firstly, a total number of releasable spaces in a plurality of data-containing blocks of a flash memory is calculated and defined as A. A total number of spaces in a plurality of blank blocks of the flash memory is calculated and defined as B. If the ratio B/(A+B) is smaller than a first threshold value, a garbage collection is performed. During the garbage collection is performed, if the ratio B/(A+B) is larger than a second threshold value, the garbage collection is ended. The first threshold value is smaller than the second threshold value.

A third embodiment of the present invention provides a solid state drive, which is in communication with a host. The solid state drive includes a flash memory and a controlling unit. The flash memory has a plurality of blocks, wherein each of the blocks comprises a plurality of pages. The controlling unit is in communication with the flash memory for calculating a total number of releasable spaces in a plurality of data-containing blocks of a flash memory, which is defined as A and calculating a total number of spaces in a plurality of blank blocks of the flash memory, which is defined as B. A timing of performing a garbage collection on the flash memory by the controlling unit is determined according to a relationship between A and B.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior art) is a schematic functional block diagram illustrating a conventional solid state drive;

FIGS. 2A-2F schematically illustrate a process of updating data and reducing invalid pages in a solid state drive;

FIG. 3A is a flowchart illustrating a garbage collection control method of a solid state drive according to a first embodiment of the present invention; and

FIG. 3B is a flowchart illustrating a garbage collection control method of a solid state drive according to a second embodiment of the present invention.

### DETAILED DESCRIPTION OF PREFERRED EMBODIMENTS

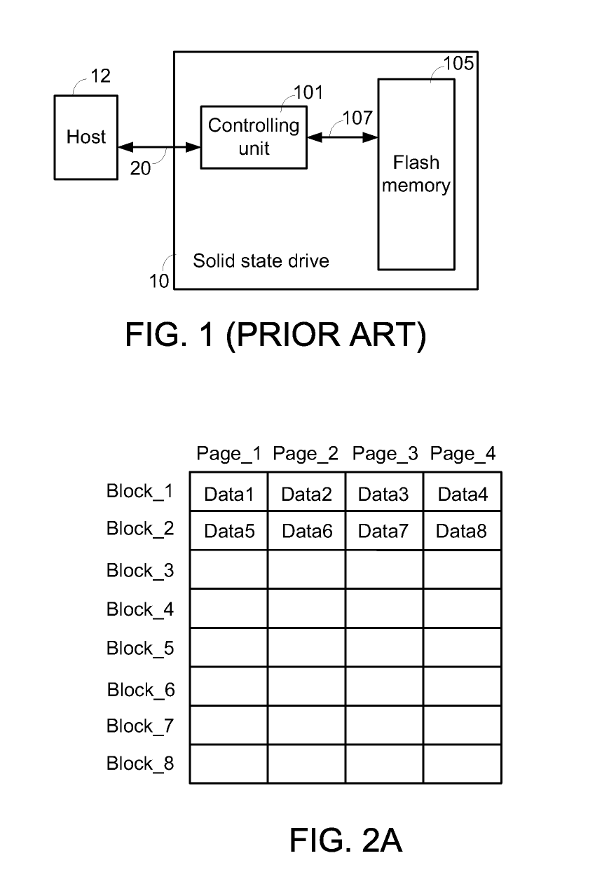

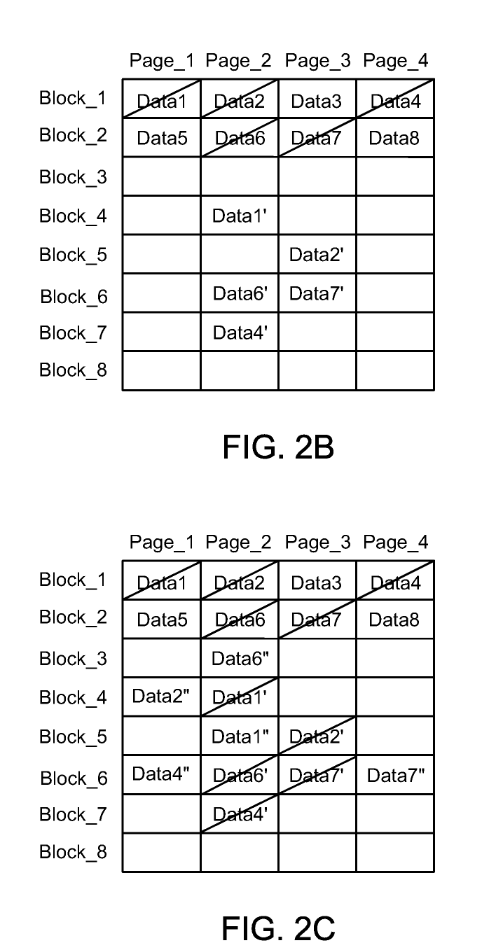

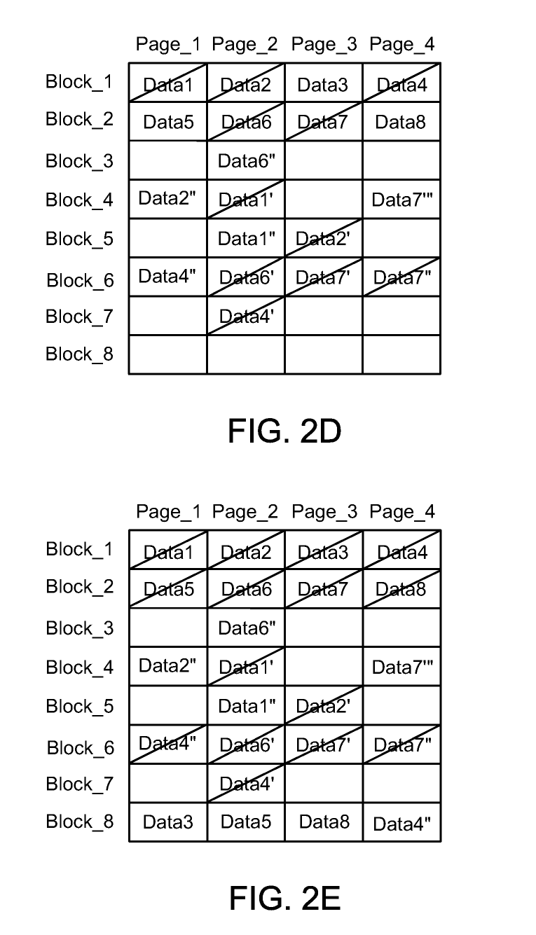

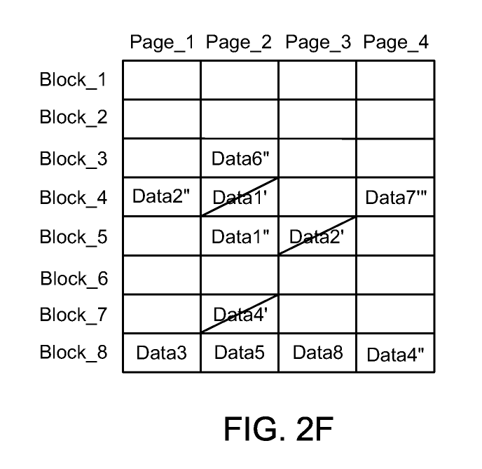

FIGS. 2A-2F schematically illustrate a process of updateing data and reducing invalid pages in a solid state drive. The architecture of the solid state drive is similar to that of the solid state drive of FIG. 1, and is not redundantly described herein.

As shown in FIG. 2A, it is assumed that the flash memory has eight blocks (Block_1˜Block_8), wherein each of the blocks has four pages (Page_1˜Page_4). The first block (Block_1) stores the data Data1˜Data4, and the second block (Block_2) stores the data Data5˜-Data8.

In a case that the host 12 wants to update the data Data1, Data2, Data4, Data6 and Data7 into the data Data1′, Data2′, Data4′, Data6′ and Data7′, respectively, the updated data will be stored in blank pages of the flash memory by the controlling unit 101 (see FIG. 2B). For example, as shown in FIG. 2B, the data Data1′ is written into the second page (page_2) of the fourth block (Block_4), the data Data2′ is written into the third page page_3 of the fifth block (Block_5), the data Data4′ is written into the second page (page_2) of the seventh block (Block_7), the data Data6′ is written into the second page (page_2) of the sixth block (Block_6), and the data Data7′ is written into the third page (page_3) of the sixth block (Block_6). From now on, the data pages originally storing the data Data1, Data2, Data4, Data6 and Data7 are considered as invalid pages, which are indicated as oblique lines.

In a case that the host 12 wants to update the data Data1′, Data2′, Data4′, Data6′ and Data7′ into the data Data1″, Data2″, Data4″, Data6″ and Data7″, respectively, the updated data will be stored in blank pages of the flash memory by the controlling unit 101 (see FIG. 2C). For example, the data Data1″ is written into the second page (page_2) of the fifth block (Block_5), the data Data2″ is written into the first page (page_1) of the fourth block (Block_4), the data Data4″ is written into the first page (page_1) of the sixth block (Block_6), the data Data6″ is written into the second page (page_2) of the third block (Block_3), and the data Data7″ is written into the fourth page (page_4) of the sixth block (Block_6). From now on, the data pages originally storing the data Data1′, Data2′, Data4′, Data6′ and Data7′ are considered as invalid pages, which are indicated as oblique lines.

In a case that the host 12 wants to update the data Data7″ into the data Data7′″, the updated data will be stored in a blank page of the flash memory by the controlling unit 101 (see FIG. 2D). For example, the data Data7′″ is written into the fourth page (page_4) of the fourth block (Block_4). From now on, the data page originally storing the data Data7″ is considered as an invalid page, which is indicated as an oblique line.

From the above discussions, after many times of accessing operations by the host 12, the flash memory 105 may contain a great number of invalid pages and invalid data (see the oblique lines as shown in FIG. 2D). Moreover, the erasing operation of the flash memory 105 is performed in a block-wise fashion. Although the flash memory as shown in FIG. 2D has many invalid pages, some data in the pages of each block are still valid data. In other words, the block containing the valid data fails to be erased by the controlling unit 101. Since the space of the flash memory is occupied by the invalid data, the writable space of the flash memory is gradually reduced. For solving the above drawbacks, a garbage collection has been disclosed. The garbage collection is a process of collecting valid pages of an old block and rewriting the valid pages into another new block. After the valid pages are collected, the pages of the old block are all changed into the invalid pages, so that the old block may be erased and reused as a blank block. Under this circumstance, the writable space of the flash memory is enhanced. Moreover, after the garbage collection is done, the space of the block with invalid pages or blank pages is released to be the available space.

Take FIG. 2D for example. During the process of performing the garbage collection, the data Data3 in the third page (Page_3) of the first block (Block_1), the data Data5 in the first page (Page_1) of the second block (Block_2), the data Data8 in the fourth page (Page_4) of the second block (Block_2) and the data Data4″ in the first page (Page_1) of the sixth block (Block_6) will be written into a blank eighth block (Block_8) by the controlling unit 101.

After the data Data3, Data5, Data8 and Data4″ have been written into the eighth block (Block_8), the data in the first block (Block_1), the second (Block_2) and the sixth block (Block_6) of the flash memory become invalid data (see FIG. 2E). Consequently, the controlling unit 101 may perform the block-erasing operation on the first block (Block_1), the second (Block_2) and the sixth block (Block_6). Then, as shown in FIG. 2F, the first block (Block_1), the second (Block_2) and the sixth block (Block_6) become blank blocks. Under this circumstance, the flash memory has more writable space.

Before the garbage collection is performed, as shown in FIG. 2D, there are eight invalid pages in the first block (Block_1), the second (Block_2) and the sixth block (Block_6). Whereas, only the eighth block Block_8 is blank to provide available space of four pages. After the garbage collection is done, the space of the eight invalid pages will be released (see FIG. 2F). Meanwhile, the first block (Block_1), the second (Block_2) and the sixth block (Block_6) are blank blocks for providing available space of twelve pages.

From the above discussions, the garbage collection may provide more writable space of the flash memory. Moreover, it is important to efficiently control the timing of starting and ending the garbage collection by the controlling unit 101.

For example, if the garbage collection is instantly started by the controlling unit 101 at the time spot as shown in FIG. 2A, the data in the first block (Block_1) and the second block (Block_2) are copied to other two blank blocks, and then the first block (Block_1) and the second block (Block_2) are erased. Obviously, the timing of the garbage collection at this moment is meaningless. In addition, since the erase count of each block is increased, the use life of the block is shortened.

Whereas, if the garbage collection is started by the controlling unit 101 at the time spot as shown in FIG. 2D, since the eighth block (Block_8) is the only blank block, only four valid pages can be moved and the controlling unit 101 fails to process and move more data pages. In other words, if the number of blank blocks is small, the efficiency of performing the garbage collection is largely reduced.

Therefore, an object of the present invention is to efficiently control the timing of starting and ending the garbage collection by the controlling unit 101.

In an embodiment of the present invention, the controlling unit 101 calculates the total number of releasable spaces in the data-containing blocks of the flash memory 105, which is defined as A. The total number of releasable spaces at least comprises the number of the invalid pages or the blank pages of the blocks. Moreover, the controlling unit 101 calculates the total number of spaces in the blank blocks of the flash memory 105, which is defined as B. According to the relationship between A and B, the controlling unit 101 may determine the timing of starting and ending the garbage collection.

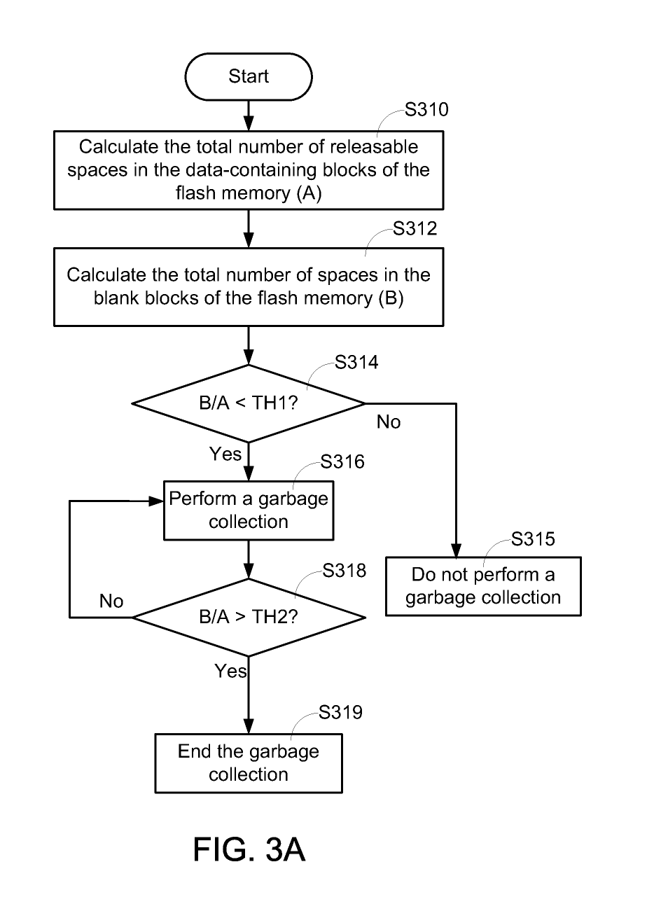

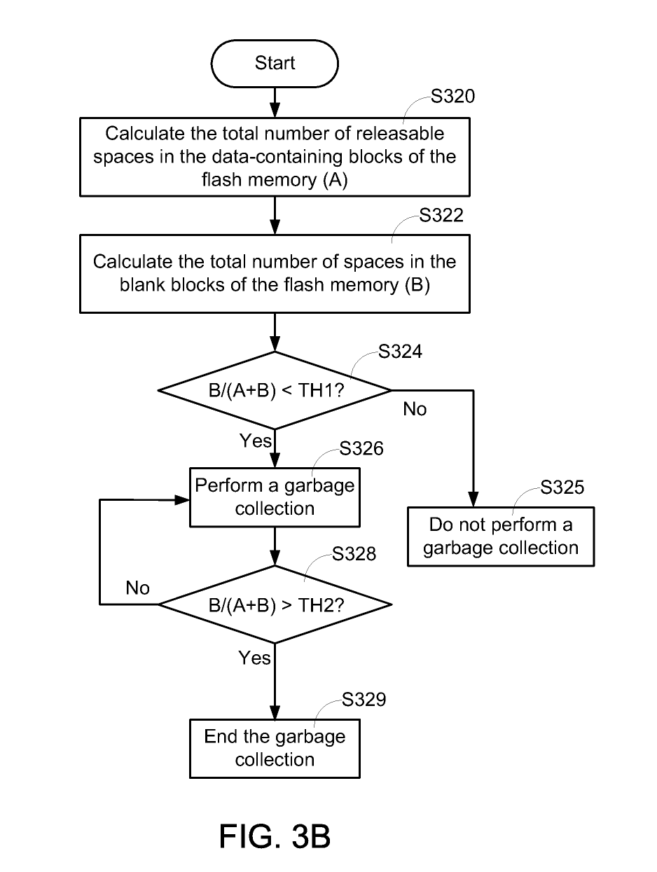

FIG. 3A is a flowchart illustrating a garbage collection control method of a solid state drive according to a first embodiment of the present invention.

Firstly, the total number of releasable spaces in the data-containing blocks of the flash memory is calculated and defined as A (Step S310). The total number of releasable spaces at least comprises the total number of the invalid pages or the blank pages in the data-containing blocks. Then, the total number of spaces in the blank blocks of the flash memory is calculated and defined as B (Step S312). Then, the step S314 is performed to judge whether the ratio B/A is smaller than a first threshold value (TH1) or not.

If the ratio B/A is not smaller than the first threshold value, no garbage collection is performed (Step S315). Whereas, if the ratio B/A is smaller than the first threshold value, the garbage collection is performed (Step S316). After the step S316, the step S318 is performed to judge whether the ratio B/A is larger than a second threshold value or not.

If the ratio B/A is not larger than a second threshold value (TH2), the garbage collection is continuously performed (Step S316). Whereas, if the ratio B/A is larger than the second threshold value, the garbage collection is ended (Step S319).

Basically, the first threshold value is smaller than the second threshold value. In addition, the first threshold value and the second threshold value are determined according to experiments by the researchers. Hereinafter, the present invention will be illustrated by setting the first threshold value as 0.4 and setting the second threshold value as 2. In addition, the total number of releasable spaces as shown in FIGS. 2A-2F will be illustrated by referring to the number of the invalid pages in the data-containing blocks.

For example, as shown in FIG. 2A, the first block (Block_1) and the second block (Block_2) are data-containing blocks. Since no invalid pages are included in these blocks, the total number of releasable spaces is 0 (i.e. A=0). Moreover, since the blocks from the third block (Block_3) to the eighth block (Block_8) are all blank blocks, the total number of spaces in the blank blocks is 24 (i.e. B=4×6=24). Under this circumstance, the ratio B/A is not smaller than the first threshold value, and thus it is not necessary to start the garbage collection.

For example, as shown in FIG. 2B, the first block (Block_1), the second block Block_2, the fourth block (Block_4), the fifth block (Block_5), the sixth block (Block_6) and the seventh block (Block_7) are data-containing blocks. Since a total of five invalid pages are included in these blocks, the total number of releasable spaces is 5 (i.e. A=5). Moreover, since the third block (Block_3) and the eighth block (Block_8) are both blank blocks, the total number of spaces in the blank blocks is 8 (i.e. B=4×2=8). Under this circumstance, the ratio B/A (=1.6) is not smaller than the first threshold value, and thus it is not necessary to start the garbage collection.

For example, as shown in FIG. 2C, the blocks from the first block (Block_1) to the seventh block (Block_7) are data-containing blocks. Since a total of ten invalid pages are included in these blocks, the total number of releasable spaces is 10 (i.e. A=10). Moreover, since the eighth block (Block_8) is a blank block, the total number of spaces in the blank blocks is 4 (i.e. B=4×1=4). Under this circumstance, the ratio B/A (=0.4) is not smaller than the first threshold value, and thus it is not necessary to start the garbage collection.

For example, as shown in FIG. 2D, the blocks from the first block (Block_1) to the seventh block (Block_7) are data-containing blocks. Since a total of eleven invalid pages are included in these blocks, the total number of releasable spaces is 11 (i.e. A=11). Moreover, since the eighth block (Block_8) is a blank block, the total number of spaces in the blank blocks is 4 (i.e. B=4×1=4). Under this circumstance, the ratio B/A (=0.37) is smaller than the first threshold value, and thus it is necessary to start the garbage collection.

During the process of performing the garbage collection, the total number of releasable spaces in the data-containing blocks of the flash memory (A) and the total number of spaces in the blank blocks of the flash memory (B) will be re-calculated in order to determine the timing of ending the garbage collection.

During the process of performing the garbage collection, as shown in FIGS. 2D-2F, the valid data in the first block (Block_1), the second block (Block_2) and the sixth block (Block_6) are moved to the eighth block (Block_8). In addition, after the data-erasing operation is performed, the first block (Block_1), the second block (Block_2) and the sixth block (Block_6) are changed into blank blocks.

Meanwhile, as shown in FIG. 2F, the third block (Block_3), the fourth block (Block_4), the fifth block (Block_5), the seventh block (Block_7) and the eighth block (Block_8) are data-containing blocks. Since a total of three invalid pages are included in these blocks, the total number of releasable spaces is 3 (i.e. A=3). Moreover, since the first block (Block_1), the second block (Block_2) and the sixth block (Block_6) are blank blocks, the total number of spaces in the blank blocks is 12 (i.e. B=4×3=12). Under this circumstance, the ratio B/A (=4) is larger than the second threshold value, and thus the garbage collection is ended.

In the above embodiment, the total number of releasable spaces in the data-containing blocks of the flash memory (A) is based on the invalid pages. Alternatively, in some embodiments, the total number of releasable spaces in the data-containing blocks of the flash memory (A) may be further based on the blank pages of the in the data-containing blocks. Hereinafter, the present invention will be illustrated by setting the first threshold value as 0.4 and setting the second threshold value as 2. In addition, the total number of releasable spaces as shown in FIGS. 2A-2F will be illustrated by referring to the number of the invalid pages and the number of the blank pages in the data-containing blocks.

For example, as shown in FIG. 2C, the blocks from the first block (Block_1) to the seventh block (Block_7) are data-containing blocks. Since a total of ten invalid pages and a total of ten blank pages are included in these blocks, the total number of releasable spaces is 20 (i.e. A=10+10=20). Moreover, since the eighth block (Block_8) is a blank block, the total number of spaces in the blank blocks is 4 (i.e. B=4×1=4). Under this circumstance, the ratio B/A (=0.2) is smaller than the first threshold value, and thus it is necessary to start the garbage collection.

During the process of performing the garbage collection, as shown in FIG. 2F, the third block (Block_3), the fourth block (Block_4), the fifth block (Block_5), the seventh block (Block_7) and the eighth block (Block_8) are data-containing blocks. Since a total of three invalid pages and a total of nine blank pages are included in these blocks, the total number of releasable spaces is 12 (i.e. A=3+9=12). Moreover, since the first block (Block_1), the second block (Block_2) and the sixth block (Block_6) are blank blocks, the total number of spaces in the blank blocks is 12 (i.e. B=4×3=12). Under this circumstance, the ratio B/A (=1) is smaller than the second threshold value. In other words, the garbage collection should be continuously performed until ratio B/A is larger than the second threshold value.

From the above discussions, after the total number of releasable spaces in the data-containing blocks of the flash memory (A) and the total number of spaces in the blank blocks of the flash memory (B) are calculated, the timing of starting and ending the garbage collection is determined according to the relationship between A and B. In such way, the controlling unit 101 is capable of efficiently managing the flash memory.

In the above embodiment, the ratio of B/A is used to determine the timing of starting and ending the garbage collection. In some embodiments, the ratio of B/(A+B) may be used to determine the timing of starting and ending the garbage collection.

FIG. 3B is a flowchart illustrating a garbage collection control method of a solid state drive according to a second embodiment of the present invention.

Firstly, the total number of releasable spaces in the data-containing blocks of the flash memory is calculated and defined as A (Step S320). The total number of releasable spaces at least comprises the total number of the invalid pages or the blank pages in the data-containing blocks. Then, the total number of spaces in the blank blocks of the flash memory is calculated and defined as B (Step S322). Then, the step S324 is performed to judge whether the ratio B/(A+B) is smaller than a first threshold value (TH1) or not.

If the ratio B/(A+B) is not smaller than the first threshold value, no garbage collection is performed (Step S325). Whereas, if the ratio B/(A+B) is smaller than the first threshold value, the garbage collection is performed (Step S326). After the step S326, the step S328 is performed to judge whether the ratio B/(A+B) is larger than a second threshold value or not.

If the ratio B/(A+B) is not larger than a second threshold value (TH2), the garbage collection is continuously performed (Step S326). Whereas, if the ratio B/(A+B) is larger than the second threshold value, the garbage collection is ended (Step S329).

Similarly, the first threshold value is smaller than the second threshold value. In addition, the first threshold value and the second threshold value are determined according to experiments by the researchers. For example, the first threshold value may be set as 0.25 and the second threshold value may be set as 0.5.

From the above description, the present invention provides a solid state drive and a garbage collection control method. After the total number of releasable spaces in the data-containing blocks of the flash memory (A) and the total number of spaces in the blank blocks of the flash memory (B) are calculated, the timing of starting and ending the garbage collection will be determined according to the relationship between A and B. In such way, the controlling unit is capable of efficiently managing the flash memory. It is noted that numerous modifications and alterations may be made while retaining the teachings of the invention. For example, the ratio B/A may be replaced by the ratio A/B, or the ratio B/(A+B) may be replaced by (A+B)/B, wherein the first threshold value is larger than the second threshold value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A garbage collection control method for a solid state drive, the garbage collection control method comprising steps of:
calculating a total number of releasable spaces in a plurality of data-containing blocks of a flash memory, which is defined as A;
calculating a total number of spaces in a plurality of blank blocks of the flash memory, which is defined as B;
judging whether a ratio B/A is smaller than a first threshold value, wherein if the ratio B/A is smaller than the first threshold value, a garbage collection is performed; and
judging whether the ratio B/A is larger than a second threshold value during the garbage collection is performed, wherein if the ratio B/A is larger than the second threshold value, the garbage collection is ended,
wherein the first threshold value is smaller than the second threshold value.

2. The garbage collection control method as claimed in claim 1, wherein the total number of releasable spaces at least comprises a total number of invalid pages or blank pages included in the data-containing blocks.

3. A garbage collection control method for a solid state drive, the garbage collection control method comprising steps of:
calculating a total number of releasable spaces in a plurality of data-containing blocks of a flash memory, which is defined as A;
calculating a total number of spaces in a plurality of blank blocks of the flash memory, which is defined as B;
judging whether a ratio B/(A+B) is smaller than a first threshold value, wherein if the ratio B/(A+B) is smaller than the first threshold value, a garbage collection is performed; and
judging whether the ratio B/(A+B) is larger than a second threshold value during the garbage collection is performed, wherein if the ratio B/(A+B) is larger than the second threshold value, the garbage collection is ended,
wherein the first threshold value is smaller than the second threshold value.

4. The garbage collection control method as claimed in claim 3, wherein the total number of releasable spaces at least comprises a total number of invalid pages or blank pages included in the data-containing blocks.

5. A garbage collection control method for a solid state drive, the garbage collection control method comprising steps of:
calculating a total number of releasable spaces in a plurality of data-containing blocks of a flash memory, which is defined as A;
calculating a total number of spaces in a plurality of blank blocks of the flash memory, which is defined as B;
determining whether a garbage collection is performed or not according to a relationship between A and B.

6. A solid state drive in communication with a host, the solid state drive comprising:
a flash memory with a plurality of blocks, wherein each of the blocks comprises a plurality of pages; and
a controlling unit in communication with the flash memory for calculating a total number of releasable spaces in a plurality of data-containing blocks of a flash memory, which is defined as A and calculating a total number of spaces in a plurality of blank blocks of the flash memory, which is defined as B, wherein a timing of performing a garbage collection on the flash memory by the controlling unit is determined according to a relationship between A and B.

7. The solid state drive as claimed in claim 6, wherein if a ratio B/A is smaller than a first threshold value, the garbage collection is performed, wherein during the garbage collection is performed, if the ratio B/A is larger than a second threshold value, the garbage collection is ended, wherein the first threshold value is smaller than the second threshold value.

8. The solid state drive as claimed in claim 6, wherein if a ratio B/(A+B) is smaller than a first threshold value, the garbage collection is performed, wherein during the garbage collection is performed, if the ratio B/(A+B) is larger than a second threshold value, the garbage collection is ended, wherein the first threshold value is smaller than the second threshold value.

9. The solid state drive as claimed in claim 6, wherein the total number of releasable spaces at least comprises a total number of invalid pages or blank pages included in the data-containing blocks.
